(19) United States
(12) Patent Application Publication
(10) Pub. No.: US 2022/0112039 A1
(43) Pub. Date: Apr. 14, 2022

(54) POSITION CORRECTION SYSTEM, POSITION CORRECTION METHOD, AND POSITION CORRECTION PROGRAM

(71) Applicant: TOYOTA JIDOSHA KABUSHIKI KAISHA, Toyota-shi (JP)

(72) Inventors: Issei MATSUMOTO, Toyota-shi (JP); Hiroshi KITANO, Nissin-shi (JP); Kenshi WATANABE, Toyota-shi (JP)

(73) Assignee: TOYOTA JIDOSHA KABUSHIKI KAISHA, Toyota-shi (JP)

(21) Appl. No.: 17/382,489

(22) Filed: Jul. 22, 2021

(30) Foreign Application Priority Data
Oct. 12, 2020 (JP) 2020-171647

(51) Int. Cl. B65G 47/90; B25J 9/16; B25J 9/00; B25J 13/08

(52) U.S. Cl. CPC B65G 47/905; B25J 9/1697; B65G 2203/0283; B25J 13/089; B65G 2203/041; B25J 9/0093

(57) ABSTRACT

A position correction system includes: one or more conveyer devices; an imaging device fixed to differential installation positions of the one or more conveyer devices and configured to image the robot to generate a plurality of captured images in a state in which the conveyer device has stopped at a predetermined stop position in a predetermined range from the robot; a position calculating device configured to calculate position coordinates of an actual reference point of the robot using the generated captured image; a correction value calculating device configured to calculate a correction value based on a difference between the calculated position coordinates of the actual reference point of the robot and position coordinates of a target reference point of the robot which is determined by simulation; and a position correcting device configured to correct the position of the actual reference point of the robot based on the calculated correction value.

### CROSS-REFERENCE TO RELATED APPLICATION

This application claims priority to Japanese Patent Application No. 2020-171647 filed on Oct. 12, 2020, incorporated herein by reference in its entirety.

### BACKGROUND

### 1. Technical Field

The disclosure relates to a position correction system, a position correction method, and a position correction program that correct a position of a robot.

### 2. Description of Related Art

In the related art, work using robots has been performed in a manufacturing line of a vehicle such as an automobile. A robot performs work based on an operation program which is generated in advance by a simulator. The simulator predetermines a target position of an arm or the like of a robot 10 that performs work on a target object. However, a difference between a target position of a robot determined by the simulator and an actual position of the robot may be caused.

In this regard, in a position measuring system disclosed in Japanese Unexamined Patent Application Publication No. 2017-19072 (JP 2017-19072 A), a measuring instrument that is installed in a manufacturing line measures a current position of a tip of a robot arm. Then, an arithmetic operation device calculates a correction value by comparing the measured current position with a target position. Then, a control device corrects a position shift of the robot arm based on the correction value.

### SUMMARY

However, in the position measuring system disclosed in JP 2017-19072 A, there is a likelihood that the measuring instrument will not be installed at a fixed installation position of the manufacturing line. Accordingly, in order to enhance accuracy for correction of a position of a robot, it is necessary to correct a current position of a tip of a robot arm measured by the measuring instrument according to the installation position of the measuring instrument. That is, it is necessary to perform a correction process due to a shift in installation position of the measuring instrument. Accordingly, in the position measuring system disclosed in JP 2017-19072 A, when a position of a robot is corrected, a correction process due to a shift in installation position of the measuring instrument has to be performed and thus there is a problem in that a time required for correcting the position of the robot cannot be shortened.

The disclosure provides a position correction system, a position correction method, and a position correction program that can shorten a time required for correcting a position of a robot.

According to an exemplary embodiment of the disclosure, there is provided a position correction system that corrects a position of a robot, including: one or more conveyer devices configured to convey an object on which work is performed by the robot; a plurality of imaging devices that is fixed to differential installation positions of the one or more conveyer devices and is configured to image the robot to generate a plurality of captured image in a state in which the conveyer device has stopped at a predetermined stop position in a predetermined range from the robot; a position calculating device configured to calculate position coordinates of an actual reference point of the robot using the plurality of captured images which is generated by the plurality of imaging devices; a correction value calculating device configured to calculate a correction value based on a difference between the calculated position coordinates of the actual reference point of the robot and position coordinates of a target reference point of the robot which is determined by simulation; and a position correcting device configured to correct the position of the actual reference point of the robot based on the calculated correction value.

The plurality of imaging devices may be provided in each of the one or more conveyer devices, the position calculating device may be configured to calculate the position coordinates of the actual reference point of each robot using the plurality of captured images of the corresponding robot, the correction value calculating device may be configured to calculate the correction value for each robot based on a difference between the calculated position coordinates of the actual reference point of the corresponding robot and the position coordinates of the target reference point of the corresponding robot, and the position correcting device may be configured to correct a position of the actual reference point of each robot based on the calculated correction value of the corresponding robot.

The plurality of imaging devices may provide the plurality of captured images to the position calculating device by radio communication.

The correction value calculating device may be configured to convert the position coordinates of the actual reference point using a conversion factor based on the assumption that the conveyer device in which the plurality of imaging devices is fixed to the different predetermined installation positions stops at the predetermined stop position and to calculate the correction value based on a difference between the converted position coordinates of the actual reference point and the position coordinates of the target reference point.

According to an exemplary embodiment of the disclosure, there is provided a position correction method of correcting a position of a robot, including: causing a plurality of imaging devices, which is fixed to different installation positions of one or more conveyer devices configured to convey an object on which work is performed by the robot, to image the robot to generate a plurality of captured images in a state in which the conveyer device has stopped at a predetermined stop position in a predetermined range from the robot; causing an information processing device to calculate position coordinates of an actual reference point of the robot using the plurality of captured images which is generated by the plurality of imaging devices; causing the information processing device to calculate a correction value based on a difference between the calculated position coordinates of the actual reference point of the robot and position coordinates of a target reference point of the robot which is determined by simulation; and causing the information processing device to correct the position of the actual reference point of the robot based on the calculated correction value.

According to an exemplary embodiment of the disclosure, there is provided a position correction program for correcting a position of a robot, causing an information processing device to perform: calculating position coordinates of an actual reference point of the robot using a plurality of captured images which is generated by a plurality of imaging devices which is fixed to different installation positions of a conveyer device configured to convey an object on which work is performed by the robot in a state in which the conveyer device has stopped at a predetermined stop position in a predetermined range from the robot; calculating a correction value based on a difference between the calculated position coordinates of the actual reference point of the robot and position coordinates of a target reference point of the robot which is determined by simulation; and correcting the position of the actual reference point of the robot based on the calculated correction value.

According to the disclosure, it is possible to provide a position correction system, a position correction method, and a position correction program that can shorten a time required for correcting a position of a robot.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a position correction system according to an exemplary embodiment of the disclosure;

FIG. 2 is a plan view illustrating an example of a manufacturing line to which the position correction system according to the exemplary embodiment of the disclosure is applied;

FIG. 3 is an elevation view illustrating an example of a work area of a manufacturing line to which the position correction system according to the exemplary embodiment of the disclosure is applied; and

FIG. 4 is a flowchart illustrating an example of a routine which is performed by the position correction system according to the exemplary embodiment of the disclosure.

### DETAILED DESCRIPTION OF EMBODIMENTS

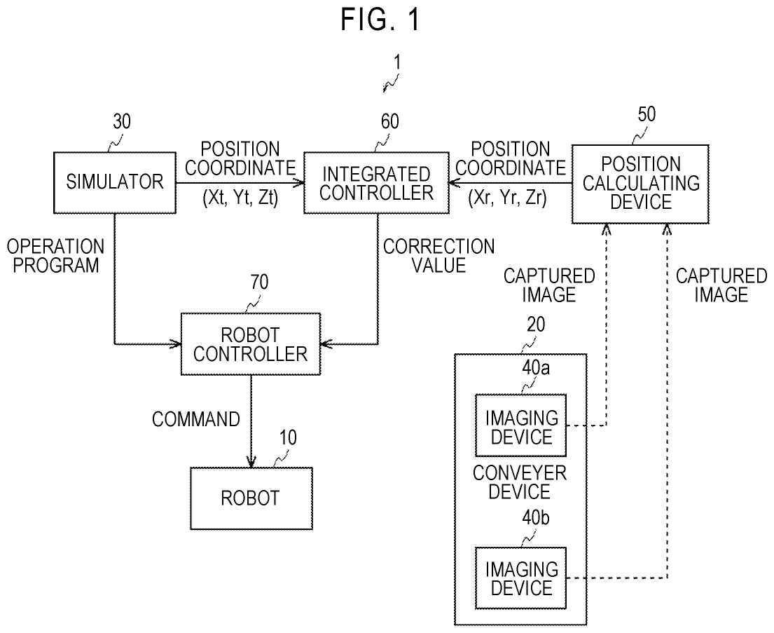

Hereinafter, an exemplary embodiment of the disclosure will be described with reference to the accompanying drawings. FIG. 1 is a diagram illustrating a configuration of a position correction system 1 according to an exemplary embodiment of the disclosure. The position correction system 1 is a system that corrects a position of one or more robots 10. The position correction system 1 includes a robot 10, a conveyer device 20, a simulator 30, imaging devices 40a and 40b, a position calculating device 50, an integrated controller 60, and a robot controller 70.

The robot 10 is a robot that performs work on a target object. Examples of the target object include vehicles such as automobiles. The robot 10 includes an arm that can perform various types of work such as welding, cutting, and assembly. A plurality of robots 10 can be arranged in a manufacturing line.

The conveyer device 20 is a device that conveys an object on which work is performed by the robot 10. A specific example of the conveyer device 20 is a work pallet. The conveyer device 20 moves to and stops at a predetermined stop position in a predetermined range of each of the plurality of robots 10 that is provided in the manufacturing line. The predetermined range is a range in which the corresponding robot 10 can perform work on a target object disposed in the conveyer device 20. In general, a plurality of conveyer devices 20 is used in a manufacturing line. Each conveyer device 20 stops at the predetermined stop position in the predetermined range from each robot 10.

The simulator 30 is an information processing device that generates an operation program of a robot 10. A specific example of the simulator 30 is an information processing device such as a personal computer (PC). The simulator 30 determines a set of position coordinates (Xt, Yt, Zt) of a target reference point of the robot 10 in a three-dimensional simulation space by simulation. A reference point of a robot 10 includes a position of an arm, for example, a work point, of the robot 10 that performs work on a target object. The simulator 30 provides the operation program of the robot 10 to the robot controller 70 and provides the position coordinates (Xt, Yt, Zt) of the target reference point to the integrated controller 60.

The imaging devices 40a and 40b are devices that image the robot 10. The imaging devices 40a and 40b are fixed to different installation positions of the conveyer device 20. The imaging devices 40a and 40b image the robot 10 to generate a captured image in a state in which the conveyer device 20 has stopped at a predetermined stop position in a predetermined range from the robot 10. The imaging devices 40a and 40b have a radio communication function and provide the generated captured images to the position calculating device 50 by radio communication. In the manufacturing line, the imaging devices 40a and 40b are provided in each of a plurality of conveyer devices 20. In FIG. 1, two imaging devices 40a and 40b are illustrated, but three or more imaging devices may be provided in each conveyer device 20.

The position calculating device 50 is an information processing device that calculates position coordinates of an actual reference point of the robot 10 using the captured images received from the imaging devices 40a and 40b. A specific example of the position calculating device 50 is an information processing device such as a PC. The position calculating device 50 calculates the position coordinates (Xr, Yr, Zr) of the actual reference point of the robot 10 using the plurality of captured images which is captured at different imaging positions on the conveyer device 20. The position calculating device 50 can calculate the position coordinates (Xr, Yr, Zr) of the actual reference point of each robot 10 disposed in the manufacturing line using the plurality of captured images of the corresponding robot 10.

The integrated controller 60 is an information processing device that calculates a correction value based on a difference between the position coordinates (Xr, Yr, Zr) of the actual reference point of the robot 10 calculated by the position calculating device 50 and the position coordinates (Xt, Yt, Zt) of the target reference point of the robot 10 determined by the simulator 30. A specific example of the integrated controller 60 is an information processing device such as a PC. The integrated controller 60 corresponds to a correction value calculating device.

Specifically, the integrated controller 60 converts the position coordinates (Xr, Yr, Zr) of the actual reference point of the robot 10 to position coordinates in a three-dimensional simulation space. At this time, the integrated controller 60 converts the position coordinates of the actual reference point using a predetermined conversion coefficient. A conversion coefficient based on the assumption that the conveyer device 20 in which the imaging devices 40a and 40b are fixed to different predetermined installation positions stops at the predetermined stop position can be employed as the predetermined conversion coefficient. Then, the integrated controller 60 can calculate a correction value based on a difference between the converted position coordinates of the actual reference point and the position coordinates (Xt, Yt, Zt) of the target reference point.

The integrated controller 60 can calculate correction values of the robots 10 disposed in the manufacturing line. The integrated controller 60 provides the calculated correction values to the robot controller 70.

The robot controller 70 is a device that controls a robot 10 based on the operation program of the robots 10 provided by the simulator 30. The robot controller 70 transmits a command based on the correction value calculated by the integrated controller 60 to the robot 10 and corrects the position of the actual reference point of the robot 10 such that the position coordinates of the actual reference point of the robot 10 match the position coordinates of the target reference point. The robot controller 70 can transmit the commands based on the calculated correction values of the robots 10 to the robots 10 disposed in the manufacturing line and correct the positions of the actual reference points of the robots 10. The robot controller 70 corresponds to a position correcting device.

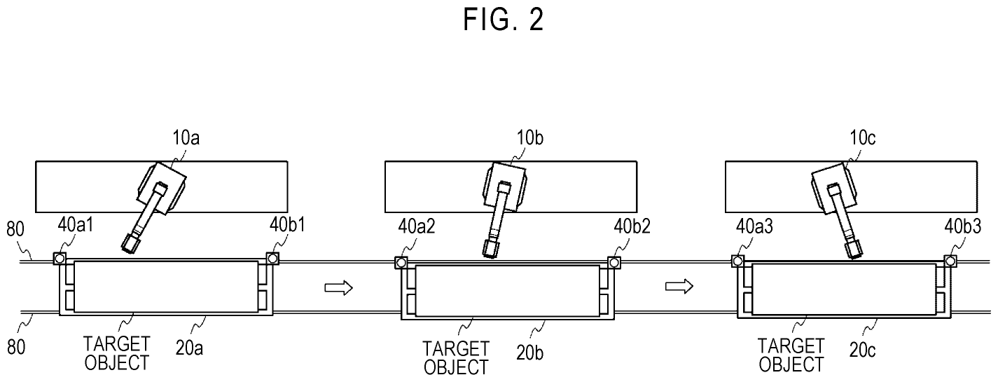

FIG. 2 is a plan view illustrating an example of the manufacturing line to which the position correction system 1 according to the exemplary embodiment of the disclosure is applied. The conveyer devices 20a, 20b, and 20c include imaging devices 40a1 and 40b1, imaging devices 40a2 and 40b2, and imaging devices 40a3 and 40b3, respectively. As illustrated in FIG. 2, a plurality of robots 10a, 10b, and 10c can be disposed in the manufacturing line. The robots 10a, 10b, and 10c can perform different types of work. Objects which are work targets are disposed in the conveyer devices 20a, 20b, and 20c.

As illustrated in FIG. 2, the conveyer devices 20a, 20b, and 20c stop at predetermined stop positions in predetermined ranges of the corresponding robots 10a, 10b, and 10c. The conveyer devices 20a, 20b, and 20c can move along rails 80 or the like and can be stopped at the predetermined stop positions by stoppers (not illustrated) which are installed in the floor. Accordingly, in work areas of the manufacturing line, the imaging devices 40a1 and 40b1, 40a2 and 40b2, and 40a3 and 40b3 and the work target objects are disposed at predetermined positions. In other words, in the work areas of the manufacturing line, only the position coordinates of the actual reference points of the robots 10a, 10b, and 10c are variable.

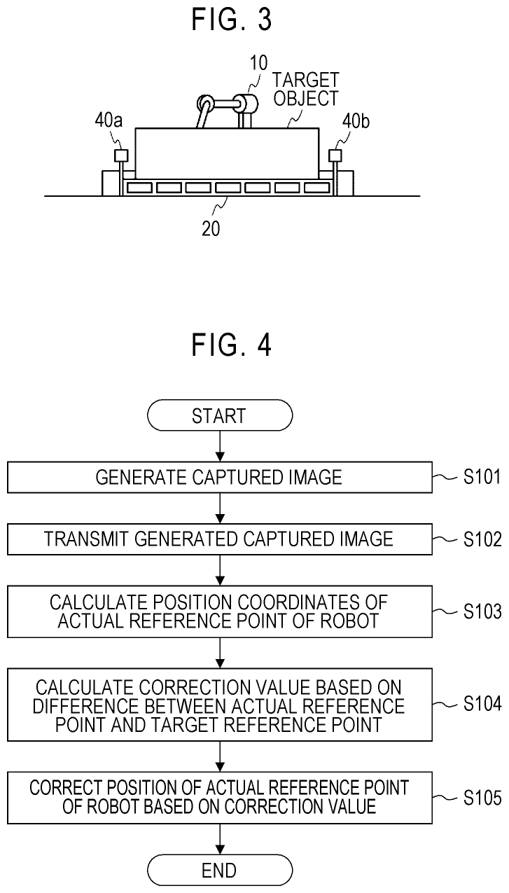

FIG. 3 is an elevation view illustrating an example of one work area of the manufacturing line to which the position correction system 1 according to the exemplary embodiment of the disclosure is applied. As illustrated in FIG. 3, the imaging devices 40a and 40b are fixed to different installation positions of the conveyer device 20 and image the robot 10. The work target object is disposed at a predetermined position on the conveyer device 20.

FIG. 4 is a flowchart illustrating an example of a routine which is performed by the position correction system 1 according to the exemplary embodiment of the disclosure. The position correction system 1 realizes a position correction method according to an exemplary embodiment of the disclosure by performing the routine illustrated in FIG. 4. The routine illustrated in FIG. 4 is performed after the conveyer device 20 has stopped at the predetermined stop position in the predetermined range from the robot 10.

In Step S101, the imaging devices 40a and 40b image the robot 10 and generate captured images. In Step S102, the imaging devices 40a and 40b transmit the generated captured images to the position calculating device 50 by radio communication.

In Step S103, the position calculating device 50 calculates the position coordinates of the actual reference point of the robot 10 using the captured images received from the imaging devices 40a and 40b.

In Step S104, the integrated controller 60 calculates a correction value based on a difference between the position coordinates of the actual reference point of the robot 10 calculated by the position calculating device 50 and the position coordinates of the target reference point of the robot 10 determined by simulation.

In Step S105, the robot controller 70 corrects the position of the actual reference point of the robot 10 based on the correction value calculated by the integrated controller 60 and ends the routine illustrated in FIG. 4.

In the aforementioned embodiment, the imaging devices 40a and 40b are fixed to different installation positions of one or more conveyer devices 20 that convey an object on which work is performed by the robot 10. The imaging devices 40a and 40b image the robot 10 and generate captured images in a state in which the conveyer device 20 has stopped at the predetermined stop position in the predetermined range from the robot 10. The position calculating device 50 calculates the position coordinates of the actual reference point of the robot 10 using the generated captured images. The integrated controller 60 calculates a correction value based on the difference between the calculated position coordinates of the actual reference point of the robot 10 and the position coordinates of the target reference point of the robot 10 determined by simulation. The robot controller 70 corrects the position of the actual reference point of the robot 10 based on the calculated correction value.

In the position correction system 1, the imaging devices 40a and 40b are fixed to the predetermined installation positions of the conveyer device 20 and the conveyer device 20 stops at the predetermined stop position in the predetermined range from the robot 10. Accordingly, in the position correction system 1, it is not necessary to perform a correction process due to displacement in installation positions of the imaging devices 40a and 40b at the time of correcting the position of the robot 10. Accordingly, it is possible to shorten the time required for correcting the position of the robot 10.

In the position correction system 1, since it is not necessary to perform a correction process due to displacement in installation positions of the imaging devices 40a and 40b, accuracy for correction of the position of the robot 10 does not decrease because the accuracy of correction of the installation positions of the imaging devices 40a and 40b is low. The imaging devices 40a and 40b do not need to be installed in the vicinity of the robot 10.

In the aforementioned embodiment, the position calculating device 50 can calculate the position coordinates of the actual reference points of the robots 10 using a plurality of captured images of each robot 10. The integrated controller 60 can calculate the correction value of each robot 10 based on the difference between the calculated position coordinates of the actual reference point of the corresponding robot 10 and the position coordinates of the target reference point of the corresponding robot 10. The robot controller 70 can correct the position of the actual reference point of each robot 10 based on the calculated correction value of the corresponding robot 10.

As described above, in the position correction system 1, it is not necessary to perform a correction process due to displacement in installation positions of the imaging devices 40a and 40b at the time of correcting the position of the robot 10. Accordingly, it is possible to shorten the time required for correcting positions of a plurality of robots 10 in the whole manufacturing line in which the robots 10 are disposed.

The robot controller 70 can correct the position of the actual reference point of each robot 10 based on the correction value of the corresponding robot 10. Accordingly, even when the positions of the robots 10 disposed in the manufacturing line are variously different, it is possible to correct the positions of the robots 10.

In the aforementioned embodiment, the imaging devices 40a and 40b provide captured images to the position calculating device 50 by radio communication. Accordingly, the imaging devices 40a and 40b do not need to be connected to the position calculating device 50 in a wired manner and thus movement of the conveyer device 20 is not hindered.

In another embodiment, the functions of the position calculating device 50, the integrated controller 60, and the robot controller 70 may be realized by a single information processing device. The information processing device can execute a position correction program according to an exemplary embodiment of the disclosure.

Specifically, the information processing device can perform the processes of Steps S103 to S105 in FIG. 4. Specific examples of the information processing device include a PC, a central processing unit (CPU), a micro processing unit (MPU), a field-programmable gate array (FPGA), and an application-specific integrated circuit (ASIC).

In the aforementioned example, a program can be stored and provided to a computer using various types of non-transitory computer-readable medium. The non-transitory computer-readable medium includes various types of tangible storage mediums. Examples of the non-transitory computer-readable medium include a magnetic recording medium (for example, a flexible disk, a magnetic tape, or a hard disk drive), a magneto-optical recording medium (for example, a magneto-optical disc), a CD-ROM, a CD-R, a CD-R/W, and a semiconductor memory (for example, a mask read only memory (ROM), a programmable ROM (PROM), an erasable PROM (EPROM), a flash ROM, or a RAM). The program may be provided to a computer using various types of transitory computer-readable mediums. Examples of the transitory computer-readable medium include electrical signals, optical signals, and electromagnetic waves. The transitory computer-readable medium can provide a program to a computer via a wired communication path such as an electrical wire or an optical fiber or a wireless communication path.

The disclosure is not limited to the aforementioned embodiments and can be appropriately modified without departing from the gist of the disclosure.

What is claimed is:

1. A position correction system that corrects a position of a robot, comprising:
one or more conveyer devices configured to convey an object on which work is performed by the robot;
a plurality of imaging devices that is fixed to differential installation positions of the one or more conveyer devices and is configured to image the robot to generate a plurality of captured images in a state in which the conveyer device stops at a predetermined stop position in a predetermined range from the robot;
a position calculating device configured to calculate position coordinates of an actual reference point of the robot using the plurality of captured images which is generated by the plurality of imaging devices;
a correction value calculating device configured to calculate a correction value based on a difference between the calculated position coordinates of the actual reference point of the robot and position coordinates of a target reference point of the robot which is determined by simulation; and
a position correcting device configured to correct the position of the actual reference point of the robot based on the calculated correction value.

2. The position correction system according to claim 1, wherein the plurality of imaging devices is provided in each of the one or more conveyer devices,
wherein the position calculating device is configured to calculate the position coordinates of the actual reference point of each robot using the plurality of captured images of the corresponding robot,
wherein the correction value calculating device is configured to calculate the correction value for each robot based on a difference between the calculated position coordinates of the actual reference point of the corresponding robot and the position coordinates of the target reference point of the corresponding robot, and
wherein the position correcting device is configured to correct a position of the actual reference point of each robot based on the calculated correction value of the corresponding robot.

3. The position correction system according to claim 1, wherein the plurality of imaging devices provides the plurality of captured images to the position calculating device by radio communication.

4. The position correction system according to claim 1, wherein the correction value calculating device is configured to convert the position coordinates of the actual reference point using a conversion factor based on the assumption that the conveyer device in which the plurality of imaging devices is fixed to the different predetermined installation positions stops at the predetermined stop position and to calculate the correction value based on a difference between the converted position coordinates of the actual reference point and the position coordinates of the target reference point.

5. A position correction method of correcting a position of a robot, comprising:
causing a plurality of imaging devices, which is fixed to different installation positions of one or more conveyer devices configured to convey an object on which work is performed by the robot, to image the robot to generate a plurality of captured image in a state in which the conveyer device has stopped at a predetermined stop position in a predetermined range from the robot;
causing an information processing device to calculate position coordinates of an actual reference point of the robot using the plurality of captured images which is generated by the plurality of imaging devices;
causing the information processing device to calculate a correction value based on a difference between the calculated position coordinates of the actual reference point of the robot and position coordinates of a target reference point of the robot which is determined by simulation; and
causing the information processing device to correct the position of the actual reference point of the robot based on the calculated correction value.

6. A position correction program for correcting a position of a robot, causing an information processing device to perform:
calculating position coordinates of an actual reference point of the robot using a plurality of captured images which is generated by a plurality of imaging devices which is fixed to different installation positions of a conveyer device configured to convey an object on which work is performed by the robot in a state in which the conveyer device has stopped at a predetermined stop position in a predetermined range from the robot;
calculating a correction value based on a difference between the calculated position coordinates of the actual reference point of the robot and position coordinates of a target reference point of the robot which is determined by simulation; and
correcting the position of the actual reference point of the robot based on the calculated correction value.
